(19) United States
(12) Patent Application Publication
(10) Pub. No.: US 2014/0195316 A1
(43) Pub. Date: Jul. 10, 2014

(54) SYSTEM AND METHOD FOR ENHANCED AND COMBINED ONLINE MARKETING AND SALES

(71) Applicants: Mikhail Vorotyntsev, New York, NY (US); Dmitriy Khmaladze, Hudson, OH (US)

(72) Inventors: Mikhail Vorotyntsev, New York, NY (US); Dmitriy Khmaladze, Hudson, OH (US)

(21) Appl. No.: 14/071,137

(22) Filed: Nov. 4, 2013

Related U.S. Application Data
(60) Provisional application No. 61/722,481, filed on Nov. 5, 2012.

(51) Int. Cl. G06Q 30/02

(52) U.S. Cl. CPC G06Q 30/0214; G06Q 30/0269
USPC 705/14.16; 705/14.66

(57) ABSTRACT

A method for managing the sale of goods and services includes coupling at least one good or service to a first hyperlink associated with the first vendor and the at least one good or service. A database tracks and stores the purchase of the at least one good or service coupled to the first hyperlink and generating a second hyperlink corresponding to the good or service as well as to both the first vendor and the first buyer, and supplying the second hyperlink to the first buyer. The first buyer may display the second hyperlink to a plurality of additional buyers, and, when each of the plurality of additional buyers conducts a transaction using the second hyperlink to purchase the at least one good or service from the first vendor, the purchase is recorded in connection with the additional buyers, the first vendor and the first buyer.

### PRIORITY CLAIM

This application claims the benefit of priority from U.S. Provisional Patent Application No. 61/722,481, filed on Nov. 5, 2012, the entirety of which is incorporated by reference.

### BACKGROUND

1. Field of the Invention

This application relates to system and method for on-line sales. More particularly, this application relates to a system and method for marketing and sales of products using customized ELinks to support viral marketing and sales.

2. Description of Prior Art

In the field of on-line sales of commercial products there are many alternative websites, such as amazon.com, overstock.com, and others. There are also popular online versions of brick and mortar retailers, like bn.com (Barnes & Noble), HomeDepot.com (for Home Depot hardware stores) and target.com (Target). However, such sites tend to be effective due to either their immense advertising budgets and/or their significant corporate infrastructure and investment. Although small merchants may interface with larger systems such as amazon.com, the pricing, tracking of sales and cross-marketing opportunities are limited for the small entity.

Other large merchant marketing sites such as groupon.com and livingsocial.com allow small merchant companies to reach larger markets. However, there are two downfalls to this system. First, these sites require that the small merchant pay a premium to the distribution site. Second, and more importantly, such systems have little control over what happens after an initial purchaser buys a particular item or service.

There are also a number of companies that specialize in what's known as network marketing or multi-level marketing which essentially uses independent distributors as both customers and sales people. These companies traditionally are large manufacturers of their own brand of products and services and do not provide any solutions outside of their closed proprietary network of independent distributors.

Another existing marketing and sales arrangement involves companies tasking themselves with providing various types of affiliate marketing technology solutions that are meant to capture customers' affinity for the merchants' products and services and to then amplify that affinity through customers' friends and social networks. These solutions may be disjointed and difficult to manage for the merchant, as they require considerable effort to integrate with existing systems to maintain operability.

For example, some merchants are increasingly recruiting customers to take part in word-of-mouth (WOM) marketing campaigns. The two most popular viral marketing strategies that have emerged to leverage the WOM effect are network targeting (seeding) and incentives (referral strategies that encourage peer adoption). Network targeting seeks to convert influential individuals who are expected to use their social network position, whether celebrity status or mere follower numbers, personal influence, and broad peer contacts to trigger cascades of product adoption. Incentives, on the other hand, motivate customers to bring friends to products through referral or various affiliate programs. These strategies can be implemented by targeting network hubs (merchants' existing customer list, Facebook, Twitter, or group-buying discounted marketing platforms like Groupon) and simultaneously provide incentives for new and existing customers alike. Incentives and Network Targeting are, therefore, complementary.

However, despite certain advantages to such marketing and sales systems, they are not, on their own, comprehensive enough for the merchants, as they require the merchant to manage the complete e-commerce transaction and they do not provide a facility for anyone to earn tiered or multi-tiered affiliate revenue. Typically, these options only provide a means to produce one special link in order to receive attribution, which is not duplicated or expanded during subsequent purchases. For example, in such arrangements the attribution ends at the first transaction as in, if blogger A installs a link and person X purchases a product through the link from blogger A, then blogger A receives revenue share as an affiliate. Amazon.com employs such a system, as well as multiple other online retailers. However, this system ends with that set of incentives, limiting the long tail extent to which buyers (e.g. buyer X) can further influence and/or benefit from additional knock-on marketing and sales.

Aside from marketing and sales concerns, the e-commerce transaction itself, using prior art systems, is still not conducive to multi-tier marketing and sales, particularly for small product vendors. For example, some prior art arrangements have tried to address the vendors ecommerce usability, from a transaction capturing and processing point of view, by enabling a simple shopping cart hyperlink capability that enables a short URL to initiate and complete the purchase of digital and physical goods through shopping cart hyperlinks. However, none of these vendors can provide an integrated affiliate system that allows the merchants to enroll their customer into a word of mouth (WoM) marketing campaign, so as to amplify their customers' peer influence, for continuous product and service diffusion throughout customers' social networks and offline circle of friends, family and community members.

There are some ecommerce vendors, such as magento and others that provide the merchant with shopping cart technology and the ability to set up a ecommerce storefront and process credit card transactions on the internet. These vendors' systems are also deficient, in that they lack effective manner for integrating their systems into an affiliate marketing technology and, most importantly do not answer a fundamental requirement for merchants, namely: how to get a customer onto their site.

As such, none of the prior art discussed above simultaneously addresses the need for a product, which allows a small merchant to make sales directly to a wide market of customers while simultaneously providing the tools to generate an effective multi-tiered affiliate/incentive sales structure conducive for use in WOM and viral marketing campaigns.

### OBJECTS AND SUMMARY

The present arrangement is for a system and method for marketing that enhances and combines marketing and merchandising by using various social and financial encouragements. The system allows, not only large, enterprise vendors, but also small and midsized vendors to easily create unique e-commerce links (hereinafter “ELinks”) which allow customers to purchase goods sold by a vendor directly from that vendor or through vendor designated distributors and retailers. This augments and realigns the existing distribution channels and in some cases eliminates the requirement for traditional third-party distributors and/or retailers who normally would purchase goods from a vendor at a wholesale price and then resell those goods to retailers or even directly to customers at a higher or retail price. These individually created and assigned unique ELinks may be attached and used by existing on-line retail, direct to consumer sites or may be created and used for facilitating sales and promotions on a product by product basis, in both online and offline retail environments, seamlessly.

In one embodiment, the present arrangement enables a customer to choose an item they desire to purchase, and connect directly to the manufacturer's website, in case where the manufacturer is also a retailer/merchant, involved in direct to consumer sales, to conduct such transaction. Importantly, the consumer or influencer or possibly “celebrity” which has recommended or directed the ultimate customer to the unique elink or website and the purchase is provided with financial compensation for such, as each sale of the unique ELinked product is tallied and corresponded to the person(s) who has recommended the product to their friends, family or followers.

As explained in more detail below in the detailed description, downstream friends, family and followers of an initial purchasers/users are able to engage in the compensation percentages for additional sales using a comprehensive multi-tiered hyperlink system. The present system and method of the present arrangement provides a running financial tallying system to reflect those multi-tiered purchase and sales of products which were directly and indirectly responsible for the purchases and sales of the same or related products to others in the chain. Thus, the present system and method is a viral-like mechanism for tracking sales to consumers, providing financial benefits to those who have promoted the product(s) and, yet, the ultimate buying consumer is still provided with a purchase benefit in the form of lower purchase pricing.

One means by which the present ELinks may be used to benefit all parties is by the ELink being passed on through word of mouth both in real world as well as through electronic means of communication, such as email, social networks etc. . . . In another arrangement, a manufacturer can incentivize the initiation of this multi-tiered process by selling a product directly to a customer via the ELink. This may be done at the normal retail price or it may be done in another example at a reduced (or wholesale) price which is not otherwise available if that consumer had purchased the same good or service through a retailer (i.e. brick and mortar location). Here, the manufacturer can thus increase its revenue by eliminating a third party retailer, which would normally share in the profits. Additionally, ELinks may be easily passed to one or more purchasers on the internet so that the new consumer, a follower of the original, may present or “percolate” the ELink for future purchases by second and third tier purchasers.

In another embodiment, each time an ELlink is used, coupling via software, the product, the manufacturer, the original buyer, the person(s) or entity(ies) recommending the same, and the downstream purchaser, the referring individual or entities are identified and each given a “credit” for the new purchase. The merchant/vendor can decide what form (whether in dollars, coupons for the same or different merchandise, points for redemption, etc.) that credit will be.

To provide one non-limiting example, every time a downstream customer (whether directly referred by the original referring individual or indirectly through an intermediate referring individual) uses an ELink to purchase a television directly from Sony™, (or possibly a smaller manufacturer of commercial goods) each purchase provides the referring entity(ies) both first tier and second tier etc. . . . , referring individuals with a credit. Here, the direct referrers of future purchases may be provided with an exemplary 5% “credit” or set of points while the second or more remote tiered purchaser/sellers are provided with 3%. This can be applied in another example to celebrity marketing, where if a celebrity buys a Sony television and then recommends the same to her friends and followers, each directly referred friend/follower, which then buys the same or a related product purchase from Sony, Sony will provide a credit in dollars, coupons, or points to the celebrity. If each of those direct friends/followers then refers or recommends the Sony television or related merchandise to their friends/followers, and those friends make purchases from Sony, the original celebrity will obtain dollars, coupons, or credits on those second tiers of purchases in the amount of 3% of the purchase price while the first set of friends of the celebrities will get 5% of the purchase price in dollars, coupons or points for their accounts. Additional details and examples are found in the detailed description.

Thus, the present arrangement provides an incentive for such information to travel electronically or by word of mouth, and that incentive takes the form of actual dollars, coupons, points, etc. in credit. Each subsequent customer who purchases a product through an ELink 1) may get a discounted manufacturer price and 2) obtains their own lower tiered ELink for use in referring the product and its manufacturer and related products to that person's followers. Each purchase results in the consumer obtaining a better deal in purchasing than if the consumer bought at retail and each purchase results in the referring individuals, whether direct, first tier or indirect, through the original referred person(s), obtaining credit for the purchase as well as credit to the direct or proximal tiers of referring individuals obtaining credit. The closer the referring individual is to the buying individual, the greater the percentage of credit and, yet, even two or more tier-away referring person(s) can obtain some credit for the downstream purchase.

In this arrangement the original manufacturer, who is now the merchant, can set the sale price for the product, and can also set the various credits or commissions paid to each level of referrals, whether a single credit is provided independent of proximity to the purchaser, or a set of different credits, dependent upon the proximity of the purchaser to the direct and indirect referring sources/individuals. The proximity of the referral to the downstream actual buyer of the merchandise can determine the level of credit or the manufacturer/seller can use a single level of credit independent of the proximity to the referral to the consumer. This not only provides an easy means to offer good value and deals to customers to purchase products directly from first level distributors, but it also incentivizes those customers to broadcast and recommend their purchases so that they obtain credits for downstream referred purchases.

The use of the unique ELink as an instrument for the sale of products and services as outlined throughout this application, provides a seamless manner for the combined sales and marketing of products and services that is advantageously implemented using a novel manner for the generation and/or coding of the ELinks. In this respect, the ELinks, as described in more detail below, include coding that allows each successive ELink in a chain of tiered ELinks to be both unique to a particular user, but simultaneously related to one another so that the system recognizes connected (sales) within a tiered framework. For example, a first referring entity and possibly the entity responsible for the recommendation of the first referring entity (the celebrity/influencer, for example) may be connected for example using the novel coding and arrangement described in the detailed description. When a subsequent buyer uses that ELink, even the top or first level purchaser (the celebrity, in one above example) who informed the second level purchaser of the product/manufacturer also receives a credit for that purchase by the two tier-away purchaser.

Such an arrangement provides a simple, active hyperlink (ELink) for shopping at a lower cost with a simultaneous incentive for downstream viral marketing campaigns without the need for brick and mortar stores, expensive purchase and storage of inventory, and/or expensive marketing gimmicks. The present invention allows a merchant to review and track the entire sales process on a product-by-product basis and by tiers or levels of referring individuals.

There are also other benefits for the customer provided by the present system and method. The first, along the lines of the benefit to the merchant, is that because each customer's purchases are able to be tracked, over time that customer will receive credit or benefits from the merchant (e.g. a customer rewards card). This allows that customer to be focused on future marketing efforts and incentive plans.

Another benefit to the present arrangement involves the implementation of the system and method in downstream marketing. For example, since small merchants do not have the capability of advertising in, and reaching, large markets of purchasers without substantial marketing budgets or a large corporate infrastructure, the bulk of their marketing is done by word of mouth, viral, social media, etc. marketing to one's friends and followers. However, when a transaction is done through an ELink, the customer who made the purchase receives, as stated above, future credit or commission to be utilized if a subsequent purchase is made by one of his or her followers. This encourages the customer to return for more purchases and also encourages buyers to make valuable recommendations. Additionally, subsequent secondary purchasers who were referred by that initial customer will also obtain a credit not only for himself but also for the person who referred him.

### BRIEF DESCRIPTION OF DRAWINGS

The foregoing aspects and many of the attendant advantages of this invention will become evident to the reviewer as the included drawings become better understood with respect to the details provided, wherein:

FIG. 1—is an exemplary block diagram of the system, in accordance with one embodiment;

FIG. 2 is an exemplary block diagram of an ELink tree, in accordance with one embodiment;

FIG. 3 is an exemplary block diagram of a multi-tiered application of an ELink, in accordance with one embodiment; and

FIGS. 4-9 are flow diagrams showing various examples of the application of an ELink via the present system, in accordance with several embodiments.

### DETAILED DESCRIPTION

### Terminology—Terminology/Definitions

Throughout the subsequent Detailed Description of the invention the following terms are used consistently throughout.

1. “The System”—denotes the system described by this application, which includes (but not limited to): the idea, software implementation, hardware implementation, practices, procedures, and system life-cycle management activities.

2. “Functions/Features”—every function of the system is denoted by F-XXX code, where XXX is a 3 digit numeric code which uniquely/unambiguously identifies the function/aspect of The System. Definitions of some functions are further broken down by a detail code.

3. “ELink”—acronym that stands for “electronic link”, which may manifest as URI (uniform resource identifier), WEB URL (uniform resource locator), printed code (bar code, QR code, or any other code). ELinks look like a short obfuscated code (e.g. “x6z23a”). ELinks are defined in more detail below.

4. “User” (of The System)—an authenticated actor of The System. Users may have different roles, which are different authorization levels.

5. “Customer/Buyer”—a role of The System user that categorizes this user as the one who buys products/services from/through The System.

6. “Seller/Vendor”—a role of the system user that categorizes this user as the one who sells products/services through The System.

7. “Organization”—an entity that allows for logical user grouping in The System.

8. “Product”—an item that Seller/Vendor users sell through The System. Products may be of various kinds: physical goods (that require delivery), digital, services. Products have additional attributes that sellers can define (e.g. “size,” “color,” “storage capacity,” etc. . . . ).

9. “Product Listing Page”—a simple page which is navigable via an ELink, a user interface that contains sufficient information/functionality to perform product checkout transaction.

10. “The System API”—application programming interface, a set of libraries and/or well-specified network calls/protocols and interfaces that allow 3rd parties (such as existing e-commerce sites/systems) to integrate with The System.

### System Structure

Description will now be given of the invention with reference to the attached Figures. It should be understood that these figures are exemplary in nature and in no way serve to limit the scope of the invention as the invention will be defined by claims, and the scope of the invention will be the scope of the claims, as interpreted by the Courts.

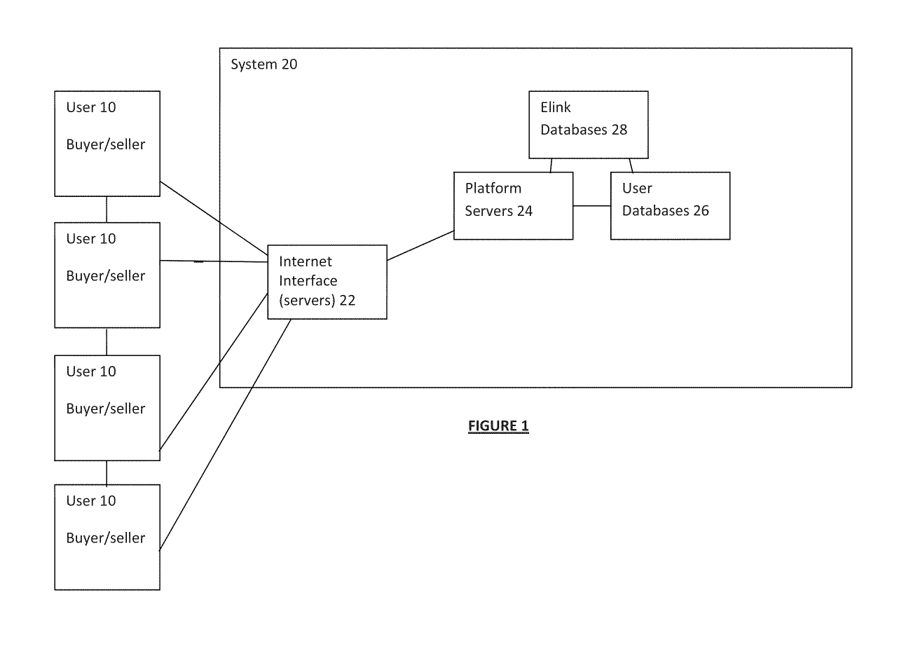

FIG. 1 is a basic overview of the system architecture of the present invention. FIG. 1 is intended to be only a basic example of some physical components necessary for carrying out the various features and functions described in detail below.

According to FIG. 1, users 10, representing customers/buyers and/or seller/vendors, are connected to the present system 20, via one or more cloud systems, servers, on computer processors. System 20 includes at least some communication servers 22 dedicated to management of processing communications between system 20 and users 10. At least some processing servers 24 are required for maintaining the software and management controls for implementing the below described functions. Coupled to processing servers 24 are at least some user databases 26 for containing various stored user data including login data, account data, transaction records etc. . . . for each of users 10 of system 20. Additionally, system 20 maintains elink databases 28 for supporting processing servers 24 in the management and storage of the various elinks and the relationships and related stored incentives as described in more detail below. Again, it is understood that this FIG. 1 and accompanying description is only one exemplary manner for arranging the components of system 20. Any additional modules needed for supporting the below described features along with the combination of modules, separation of modules etc. . . . are all within the contemplation of the present invention.

### Functions/Features

Turning to the functions of the present arrangement, the following is an exemplary list of numbered features (FXXX) explaining in short summary the various functions of the present system 20 particularly with respect to the creation and use of the presently described Elinks.

F-001 System 20 may be advantageously internet/cloud-based, accessible all around the world via HTTP-enabled devices (web browsers) on both stationary and mobile platforms.

F-002 System 20 maintains user 10 identity information, authenticates and authorizes users 10, depending on user 10 role assignment, to perform various kinds of functions which are described below.

F-003 System 20 may authenticate users 10 via popular 3rd party social sites (Twitter, Facebook, Google+, MSN, LinkedIn, etc.) if users 10 elect to link their identities from those sites with system 20.

F-004 For every user 10, system 20 maintains all financial records, transactions that have been performed through system 20 for example in databases 26 and 28. Users 10 may view their transactions at any time.

F-005 System 20 facilitates quick checkout experience by storing relevant information (shipping address, billing address) and financial information, such as credit card numbers for each of users 10. In one embodiment, such information is stored only if user 10 wishes to do so. User sessions are kept active for extended periods of time so that user 10 does not need to re-type many identification tokens often, however special measures are taken for identity protection (as described in more detail below).

F-006 System 20 offers users 10 fine-grained control of what information is stored in system 20 and what information is made publicly visible to other users 10. Users 10 may have their profiles stay dormant/invisible to the public.

F-007 System 20 advantageously provides an elaborate user identity verification function, using CAPTCHA (Completely Automated Public Turing test to tell Computers and Humans Apart™) and PIN (Personal Identification Number) codes so that long-lasting user sessions are protected. The protection mechanisms are designed in such a way that user 10 does not need to type-in many characters (which is important on mobile devices), rather gestures and PIN codes are used.

F-008 New user 10 registration may be integrated with checkout, thus providing the unified experience of becoming a registered user 10 on system 20. Upon making subsequent purchases, user 10 information is already available at the checkout phase. Additional functionality of cross-linking of user 10 identity in system 20 and popular social networks organically integrated, so if users 10 elect to log-in with their existing social account (i.e. Facebook or Twitter), the information from those networks is defaulted into the newly created user profile in system 20.

F-009 User roles are Buyers(Customers) and Sellers(Vendors).
F-009A The act of buying is going through the checkout process, thus anyone who has ever bought anything through the system has a user record with “Buyer” role granted.
F-009B “Seller/Vendor” role is granted to those users who have to purposely register this way by navigating to “Sell Something” (or similar) section on The System site
F-009C Any user may be a Buyer and a Seller at the same time.

F-010 System 20 advantageously maintains a product listing page which is a web page (user interface) that has enough information to describe the product, allow customers(buyers) to change product options (if sellers defined any), such as: “size”, “color”, etc., specify delivery options (when applicable) and process financial transaction electronically in real time. The product listing page is identified by a unique ELink which is attached at the end of the DNS server name that system 20 operates of, (e.g. “https://sys.co/x56az8” (server name used for illustration purposes only)

F-011 System 20 preferably always use SSL (Secure Socket Layer) industry standard encryption scheme for all traffic between servers 22 and 24 and users 10 except for cached content like stock pictures (non-product) and CSS/java script that does not contain any user-specific information.

F-012 ELinks are short alpha-numeric strings of characters that uniquely identify various data records in system 20. Primarily, ELinks are used to identify the product listing along with all logically connected attributes, such as (but not limited to): product seller, referrer (direct or indirect seller's affiliate), product version/options (when applicable), SKU, inventory location (for physical products) etc. . . . ELinks are generated by system 20, and resolved (understood) by system 20.
System 20 employs special algorithms to:
   F-012A keeps ELinks as short as possible
   F-012B protect ELinks from forgery attempts
   F-012C minimize user confusion i.e. either use “1” (one) or “l” (lower-case L) but never both. Use case-insensitive coding
F-012D prevent the formation of profane language that may occasionally happen in computer-generated identifiers
Because of their shortened nature, ELinks are suited for being published on blogs, social sites, emails, and for being communicated verbally between users 10.

F-013 Referrer/Percolating user is a direct or indirect seller affiliate—a user 10 registered in system 20, that can spread the ELinks further down the social chain of friends/contacts. When user 10 derives/percolates a new link from an existing one—he/she becomes a referrer.

F-014 Percolation/Spreading/Referring/Contagion is the process of creation and spreading of derivative ELinks in the social mediums (i.e. social networks), newspapers, WOM (word of mouth) and by any other means. The process of percolation/referring/spreading forms a directed acyclic graph of links as explained in more detail below.

F-015 A derivative ELink (or child link)/Referring link—is a new link which was created from the original ELink (parent link) that the referrer (F-013) somehow obtained (i.e. by receiving an email, SMS, WOM, or scanning a QR code, visiting a social network site etc.). The original parent links represent a product item and its referrer (which may be the original seller), along with the whole chain of derivation/reference from the original seller (because the parent link may have another parent link and so on up to original seller).

F-015A A chain of derived ELinks form a directed acyclic graph, that possesses the following properties:
The first ELink in the graph is generated by the seller and represents a root of the graph
Any graph has only one root ELink (point of entry, only one seller)
Only the root ELink of the graph does not have a parent ELink, which signifies that this link is an original seller-created ELink
Any ELink which is non-root ELink may only have one parent
Cyclical ELink references are prohibited, that is—there may be no ELink in the graph whose parent does not directly or indirectly derive from the very root

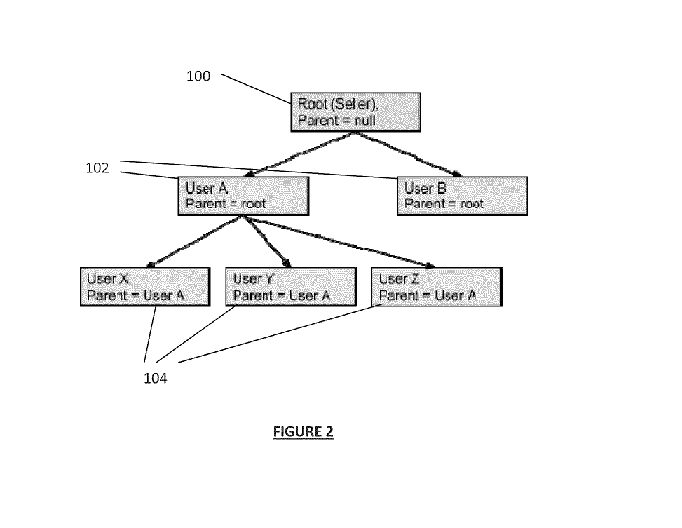

See for example FIG. 2, showing a root Elink 100, two non-root first tier Elinks 102 and three second tier Elinks 104, each having only one parent from first tier Elinks 102.

F-016 A user may percolate (spread his/her own derived link) an ELink if:
F-016A user 10 has bought the product from original (root) link 100
F-016B user 10 has not bought the product from original (root) link 100, but the product seller of root link 100 allowed the product to be percolated/spread anyway from his/her root ELink 100
F-016C The definition stated in F-016B is kept in the ELink, not the product.

F-017 Every time there is a purchase of a product (which is identified by an ELink) in system 20, all users 10 in the chain of link references (FIG. 2), starting from the original seller get a credit for the sale. There are credits of two kinds:
F-017A percolation/influencer credit, measured in number of eventual sales
F-017B money credits measured in $ earned from the sales margin

The two types of credits are needed to give referring users 10 incentives in all kinds of cases, even when the monetary reward is very little per every sale (i.e. 3+degree of the network), however the peer-influence is always accounted for.

F-017C The abuse/spamming problem was considered for this invention, and it is understood that one cannot “spam” the links to get higher influencer credit (F-017A), as those actions will not result in any actual sales, if they do—that means that the individual user does possess the beneficial peer influence. In other words—it is not possible for any user 10 to boost their score by ELink manipulations if those actions do not result in actual sales generated by many actual buyers who get their identities verified by the means of electronic payment processing during checkout.

F-018 Percolator/Influencer credit reflects the “influencing power/weight” of the particular user 10 in system 20.
F-018A at the certain levels of this score, system 20 may require the original seller to provide certain minimum level dollar discount to the user who achieved that level.
F-018B high-power user 10 sets the requirement for profit sharing margins.
F-018C a typical kinds of users 10 who would qualify for this condition are celebrities and/or people who have large social following who can demand to exchange their peer influence for dollar credits.

F-019 Monetary credit is given to referrers who either:
F-019A qualify per the rule stated in (F-018B)
F-019B do not qualify per (F-018B), however seller has set percolation margin (that instigates network diffusion) on the product root ELink 100 and all other tiers in the reference chain get portions of the discount distributed.

F-019C The monetary credit is given according to the formula which takes in account all of the tiers of percolation starting from the top of the chain (closer to seller).

F-020 A product is what sellers sell.
F-020A The system supports physical goods, digital products and services.
F-020B Sellers can create root links 100 for products in system 20 by going through a wizard-like setup, uploading photos and descriptions, additionally every product may have custom options/attributes (i.e. “weight”, “color”, “size” etc.).
F-020C Every products is categorized with tags that reflect different aspects/interests/target audience.
F-020D Product base price is set by seller, however it can vary depending on product-specific parameters (i.e. t-shirt less than size “L” $4, over size “L” $4.45”) as defined by seller.

F-021 While listing a product, a seller creates any number of root ELinks 100 where every link contains the % of discount and permissions for downstream members to percolate. The permissions are described in F-016.

F-021A Optionally, a seller may set a minimum purchase quantity constraint which is applicable only to certain types of products (i.e. physical goods, licenses, tickets, etc.)—this would allow wholesalers to sell via system 20.

F-022 Sellers may browse within system 20 a stored list of users 10 by product categories (who percolated/sold similar products) who offer their peer-influence for dollar sales commission (F-018B), thus a potential seller may directly contact a high-influencing user 10 with the proposition to percolate his/her product via the messaging system which is integrated in system 20. The high-power user may review the proposition and the product and decide to percolate it in his/her network.

F-023 When listing products in system 20, sellers may group items by relevance thus forming a “catalogue” of items.

F-024 Product listing page, which is uniquely identified by ELink) lists a particular product sold by the seller. However, the interface may offer an option to the buyer to browse more products from the seller's catalogue (F-023), if the seller has one (when seller sells more items).

F-024A a buyer may elect to add the originally-linked item to the “shopping cart” and then browse for more items from the catalog also adding those extra items to the cart. This way a buyer may save on shipping charges and checkout multiple items at once.

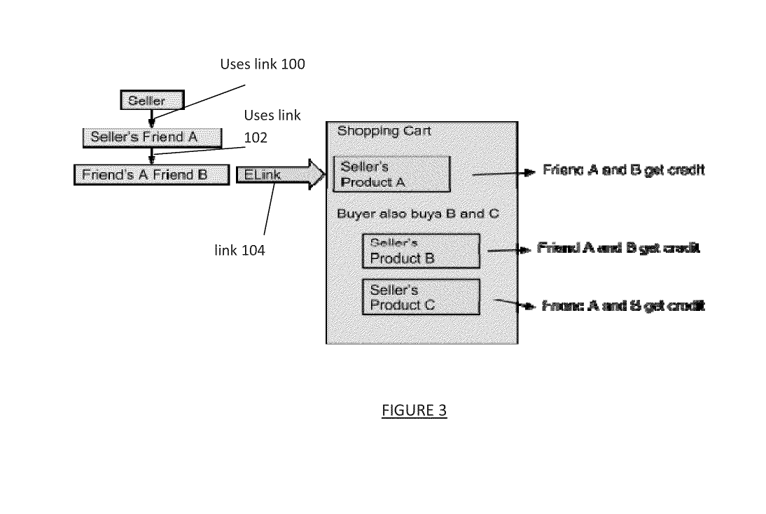

F-025 When a customer/buyer checks-out more than one item/product, the ELink derivation/percolation graph is used from the original link that led the customer to the very first product listing page, so participants of that chain get credited for every item purchased. See for example the attached FIG. 3, where an original root link 100 (seller) is used to sell a product A to a Friend. The generating first tier link 102 at friend A for product A is then used by Friend B to purchase product A, which in turn generates a second tier link 104 which is then reposted for subsequent sales. Thereafter if that link 104 is used by a purchaser (shopping cart) to product A from the seller using link 104 (which includes references to both Friend B and Friend A, then Friend A and Friend B would get credit from seller for the sale of product A. And, if the new purchaser using link 104 during the shopping phase initiated by this purchase, then also buys products B and C from the seller then Friend A and Friend B would also get credit for those purchases as well. The definitions and amounts of all aspects of such credits may be advantageously set by seller as discussed above).

F-026 A product ELink may be password-protected by its creator in one of the following ways:
F-026A a password to display the page may be required.
F-026B product page shows without password, but password is needed to add item to cart/checkout.

The passwords may be used in cases when ELinks are publicly displayed at some gathering but only certain qualifying individual may take advantage of those links.

F-027 Search engines (Google, Yahoo, Bing, etc.) are advantageously allowed to index only the very root links 100 (i.e. seller links), not percolated links.

F-028 For physical goods sold through system 20, integration with major delivery carriers (UPS, FedEx) shall be provided.

F-029 In one embodiment there may be a paid level (GOLD+) for users 10 of system 20 that unlocks certain features, e.g. ability to set percolation prices by hand.

### Explanation and Use of Above Described Features

As noted above, the present arrangement as shown in FIGS. 1-3 and as explained in the above described features provides for a cloud-based (F-001) electronic commerce system 20, where the products are advertised/marketed in the social mediums by means of short ELinks (F-012) (100 . . . etc) exchange.

This arrangement is very distinct from existing prior art e-commerce solutions which promote monolithic store-front concepts without referral attribution capabilities, unlike the present system 20 where the following combination of data is uniquely identified by the means of ELinks (100 . . . ):
1. Product listing with all necessary attributes that apply to a particular product (price, size, color, weight etc.) and the seller/vendor;
2. Referrer, where the referrer may refer the product listing based on another referrer that he/she received via network contagion process.

Such a unique design promotes for example:
1. Easy posting/broadcast of links in social mediums, emails, campaigns etc. . . . ;
2. Referrer tracking and eventual sales attribution.

System 20 allows individuals to monetize their peer influence, e.g. a celebrity that has large following on social sites or in the media, so that they may easily convert his/her influence into sales commissions (See e.g. F-018B, F-022). For example, a TV show guest may display an ELink (100, 102 . . . ) as a QR code during the show broadcast, the TV audience can scan it and buy the product, crediting all of the sales to the celebrity account in system 20.

Per the proposed invention, the product listing (F-010) reaches a much broader customer audience by means of social contagion which is instigated by participating users who get credited for spreading links (percolation). This scheme possesses an important aspect of peer influence, as buyers are more likely to buy products that their peers (friends, social contacts, etc. . . . ) have already bought and recommended.

Another advantages is that present arrangement can work to make many brick and mortar locations virtually inventory-less as the invention promotes information-only operations. The product listing page (F-010) is served via a unique ELink (F-0012) with the sharp focus on quick and easy checkout (F-005)

The following are a few exemplary flow diagrams illustrating the salient features of the invention. (Note: all human, product names, places, prices and addresses used in this section are fictional for illustration purposes only)

### Example 1

### Commission Distribution Example—Same Percolation Price (Default Case)

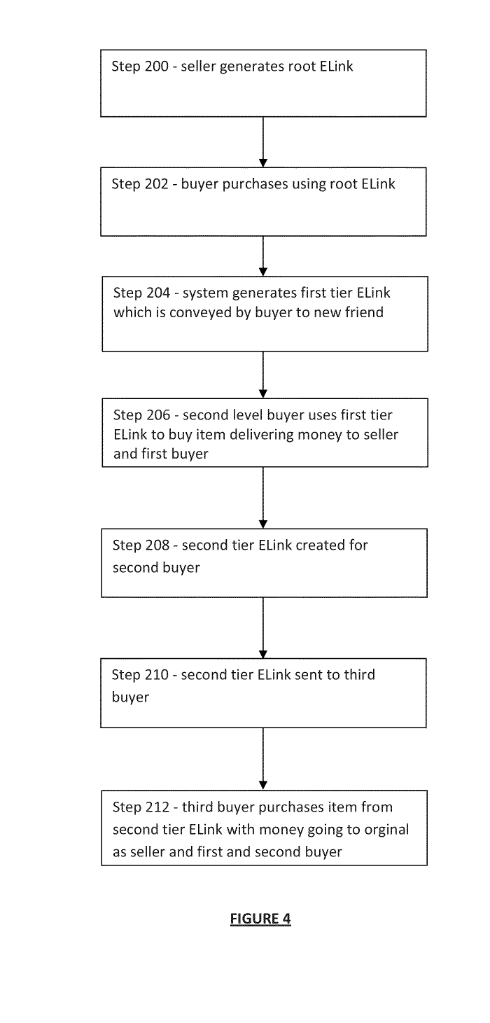

This example as shown in FIG. 4 shows how sales commission is distributed among ELink chain owners that do not have capabilities to set custom prices (regular users 10). This example covers a common use-case for System 20.

In this example, a seller “Natur-All” sells a certain kind of soap bar for $80 a piece in shopping malls around the country. They also sell the same soap for lesser price, e.g. $60 a piece, on their website, where users may not buy more than 5 pieces. According to the present arrangement in a first step 200, Natur-All creates a root ELink 100 in system 20, that gives checkout price of $50 and $5 is assigned to network product diffusion, consequently they get $45/bar+viral marketing benefit. Next at step 202 it is contemplated that a first user/buyer 10 Alex uses root ELink 100 and spends $50 at checkout at which point Natur-All gets $50. At the same time, at step 204 a new first tier ELink 102 is derived from the original one, and Alex sends link 102 to a second user Tim.

Upon receiving link 102, at step 206, Tim pays $50 at checkout, out of which $5 goes to Alex and $45 to original seller. At step 208 a new second tier ELink 104 is created for Tim, that at step 210 Tim sends to Jim. Once Jim gets the derived second tier ELink 104 from Tim, at step 212 he pays $50 at checkout, out of which $45 goes to the original seller and $5 is split between Alex and Tim according to one of the formulas that seller Natur-All established. (e.g. one of the formulas will split even and give $2.50 each). It is noted that the same price of $50 is paid for the product at all levels of percolation chain. This model is important for indexing, as search engines such as Google will index only root ELinks 100's. There is no need to hunt for better percolation deal, as they are all the same.

### Example 2

### Commission Distribution Example—Different Percolation Prices

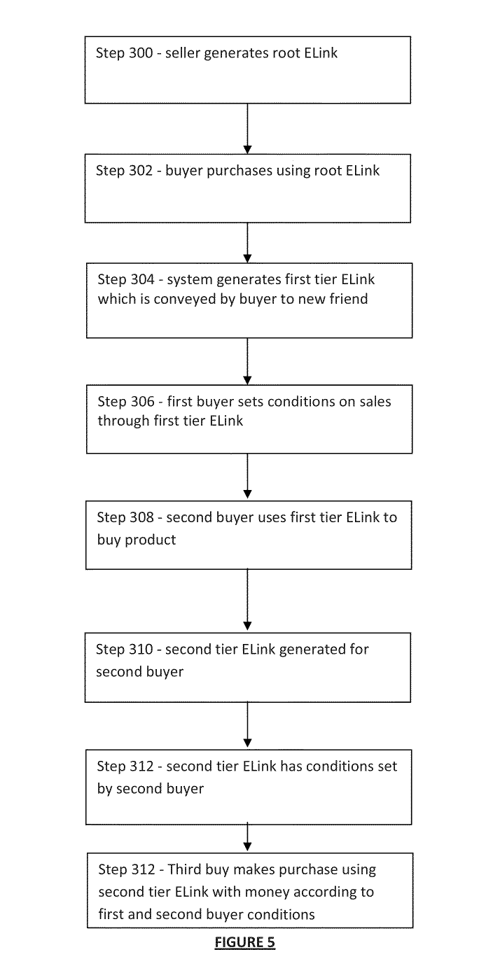

This example as shown in FIG. 5 shows how sales commission is distributed among ELink chain owners, that do have capabilities to set custom prices (e.g. GOLD customers+users 10), in order to set custom prices/margins a user 10 must have certain membership level in system 20.

In this example, same as Example 1, “Natur-All” sells a certain kind of soap bar for $80 a piece in shopping malls around the country. They also sell the same soap for $60 a piece on their website, where users may not buy more than 5 pieces.

At step 300, Natur-All creates a root ELink 100 in system 20, that gives checkout price of $50 and $5 is assigned to network product diffusion, consequently they get $45/bar+viral marketing benefit. Alex is a GOLD user 10, so he can set prices/margins directly. At step 302 Alex uses root ELink 100 and spends $50 at checkout, Natur-All gets $50. At step 304 new first tier ELink 102 is generated from the original root ELink 100, and Alex sends it to Tim. Unlike Example 1, at step 306, Alex may set a condition regarding first tier link 102, that he wants to make $3 per downstream purchase bringing the sales price to $48.

At step 308, Tim gets the first tier ELink 102, pays $48 at checkout, out of which $3 goes to Alex and $45 to original seller. At step 310 a new second tier ELink 104 is created for Tim, which Tim sends to Jim. As above with Alex, at step 212, Tim can set the condition that Tim decides that he has many friends that would buy what he recommends, so he demands $4 from every downstream purchase, effectively that sets a product price of $52, which is higher than the original's seller price, but since many friends of his would not care/have ability to find the original root ELink 100, they may proceed @ $52/soap bar.

At step 314, Jim gets the derived second tier ELink 104 from Tim, pays $54 at checkout, out of which $45 goes to the original seller and $4 goes to Tim and $3 goes to Alex=>$52−$4−$3=$45.

### Example 3

### Custom T-Shirt Maker

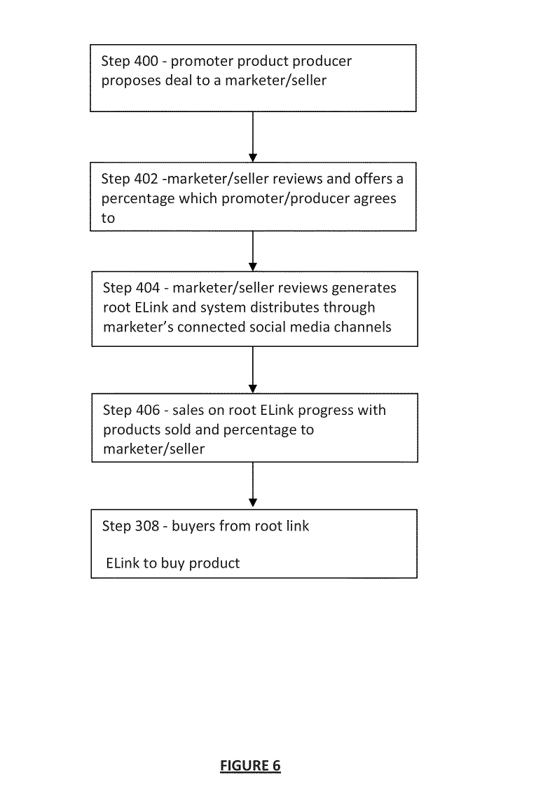

This example as shown in FIG. 6 shows how a manufacturing vendor may utilize a peer-influence of a celebrity to boost sales using system 20.

In this example, “LogoWare” is in business of making custom-imprinted t-shirts.

Bob X works in the sales department and learns that there was a large community rock concert in the area last night where the famous local rocker Jack Z told a joke about his pet cat. Instantly the story made it to the top Twitter/Facebook feeds in a 2,000,000-people metro area. Bob decides to imprint “My Cat Rocks!” on t-shirts and sell it through Jack, as Jack has around 100,000 local musicians following him directly on Twitter and Facebook in the area plus their friends who also know who Jack Z is.

In a first step 400, Bob logs into system 20, finds Jack's profile and writes him a message attaching a sample picture of the t-shirt with the popular slogan from that concert event. At step 402 Jack gets a message, logs-in to system 20 and responds with 10% commission proposition. At step 404 Bob agrees, and Jack creates an root ELink 100 with the product attached which is broadcasted in all of his connected social networks by system 20 (no need to click 100,000 times).

At step 406, within the next 24 hrs around 100,000 people see/pay attention to the social post from their favorite local celebrity that they follow about the fabulous T-Shirt product, this eventually results in a wave of sales via the particular root ELink 100, where Bob's business “LogoWare” profits from many sales and Jack Z gets 10% from every sale monetizing his peer influence. Furthermore, at step 408 every buyer may percolate/spread his/her personal link in their social networks using first tier ELinks 102 creating a viral contagion effect which results even in more sales all trickling down to “LogoWare” via Jack Z who gets 10% commission, possibly with additional commissions to the first buyers, if seller allows for such in the initial conditions.

### Example 4

### Brick-and-Mortar Jeans Seller

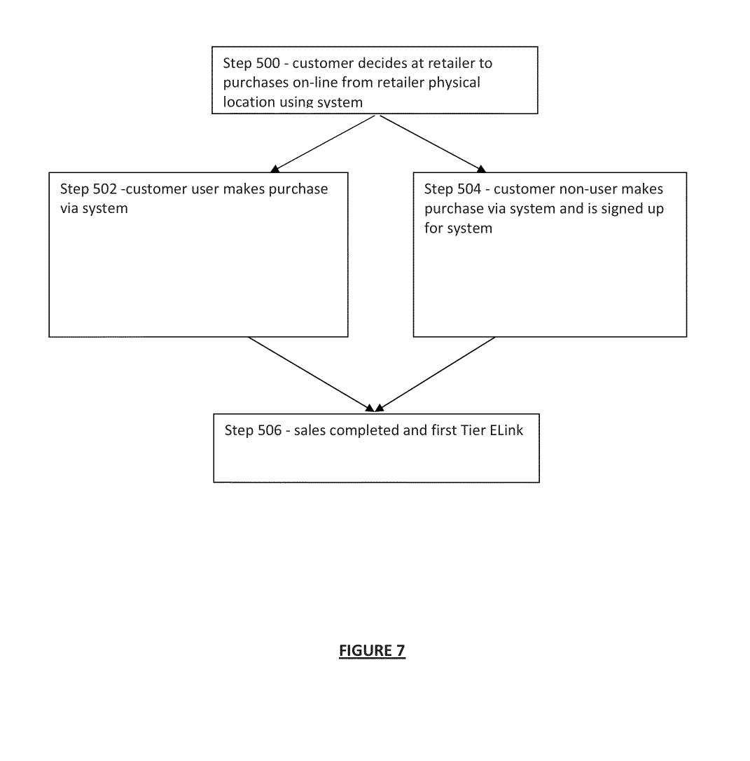

This example as shown in FIG. 7 demonstrates how a re-seller can optimize his operation using ELinks via System 20.

In this example, Rob X owns a physical store location “JnZ” in Brooklyn, selling various brands of jeans. The biggest challenges in his business are: a) source the customer, and b) the cost of carrying the inventory on hand. When a typical customer walks into the store to try a pair of jeans on they may decide to purchase. In this instance at step 500 the retailer may give that customer a choice to pay full price and walk out with a pair of jeans or get a 10% discount and have the jeans delivered next day to the customer's address of choice. If the customer chooses the second option, the sale is consummated via system 20.

In the case where the customer is already a user 10 of system 20, at step 502 he simply scans the barcode on the jeans of his choice and completes the transaction inside a dedicated system 20 app (e.g. mobile device application). If the customer is not a user 10 of system 20, then at step 504 retailer completes the sale via the Elink website and captures the customer's information and processes the sale, just like a sale would be processed if it were originated on an ecommerce site. In both cases at step 506, along with the store purchase, a first tier ELink 102 is created for the buyer (the root ELink 100 is embedded or attached to the product for the initial sale).

By facilitating the sale of merchandise for future delivery, the retailer has created a Elink chain as in the above examples 1-3 that originates with that retailer, flowing through that customer and any other purchase that is made via that customer's friends or social networks, the retailer earns a percentage, based on a particular compensation grid. Additionally, the store has the advantage of limiting the amount of physical merchandise needed at the store. In this respect, system 20 creates a homogeneous environment, which does not distinguish where the storefront is, whether on the retailer's web-site, affiliate partner's site, customers' social networks feeds or the physical storefront.

### Example 5

### Restaurant—Service Retail

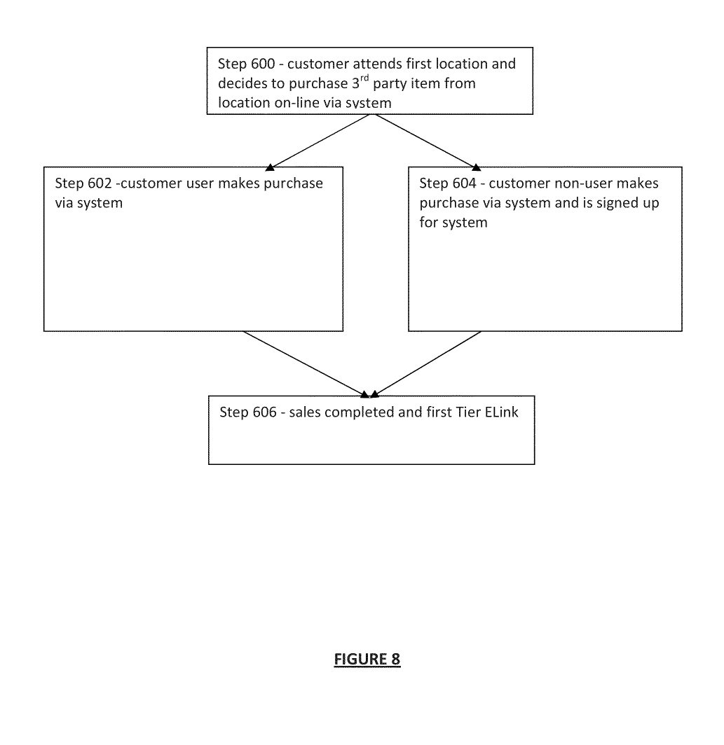

In this example shown in FIG. 8 an Italian restaurant, which is a service retail establishment, does not carry any inventory, but through the use of system 20 can participate in sourcing the customer and earn long-tail compensation as a result.

At step 600, customers coming in for dinner can sample authentic Italian Olive Oil or specialty sauces or any other food or gift items and can purchase these for home delivery, while they are enjoying dinner. At step 602, if the customer is a user 10 of system 20, the entire transaction is conducted through a mobile app for system 20, via use of proprietary or standard QR/barcodes on the particular items, where a customer would scan the item's code and proceed to either save it in his wish list folder or check out for delivery. At step 604 if the customer is not a user of system 20, then a retailer would process the sale via a mobile application, either on a smartphone or a tablet computing device, via input of customer's credit card and billing address information, similar to how it would be done on an e-commerce site.

In both instances at step 606 the purchasing customer is provided with a next tier ELink which they can use to subsequently blog or publish for future marketing and sales as discussed in the above examples.

### Example 6

### Beauty Spa—Service Retail

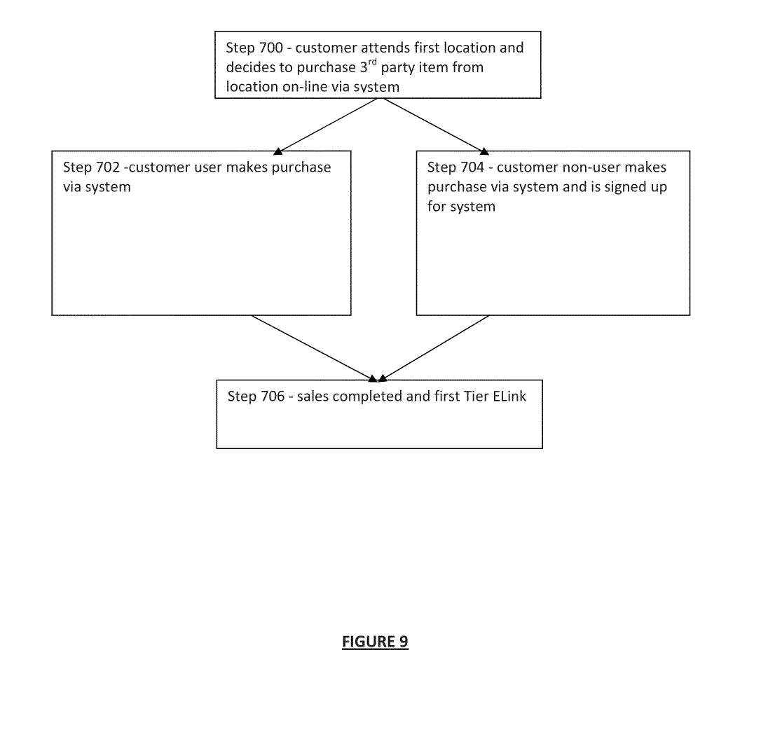

In this example shown in FIG. 9, a beauty spa, primarily a service retail establishment, may use their check out area for retail sales of skin care products via system 20.

At step 700, a customer upon completing a beauty procedure can choose a skin care product(s) for purchase (home delivery). As in the examples above, at step 702 a user 10 can complete the purchase on their phone, and if not a user at step 704, the retail location can assist in signing the user up and making the sale in a single transaction.

In both examples 5 and 6, depending on the arrangement between the product seller and retail location the original ELink may be a root ELink 100 or a first tier ELink 102 depending for example if the retail location is getting a percentage of the sales.

In both instances at step 706 the purchasing customer is provided with a next tier ELink which they can use to subsequently blog or publish for future marketing and sales as discussed in the above examples.

### Additional Features and Advantages of the System

Further to the system structure, functional aspects and use examples discussed above, the present invention may include additional features and advantages. For example, in one embodiment, in the background of the software and internet site of the present system 20, a user 10 profile may be created for each user 10 from that customer which stores all the purchases made by that consumer and is tied either to a credit card, an email address, or any other means of unique customer imprint.

That profile can be considered a “shade,” and can be activated by the customer so it becomes visible or “lit” to other potential purchasers. When a profile is in the “shade mode,” it is invisible to all except user 10 to whom it belongs. Alternatively, when that profile is “lit,” it can be seen by other potential users 10 who have a profile, and browse profiles to see what others are buying, what is trending, who has the highest accumulated credit or referral scores within system 20. Merchant users 10 can provide better values and deals through ELinks of highest scoring or credited users 10, allowing them to earn better, more, different credits or rewards. These credits or rewards can come in the form of higher percentages of credit, and they provide even deeper discounts to other or the same of the user/manufacturer's products. Essentially, other users 10 can look to see who the most active buyers are and what products are trending that they are buying. Activation of an account would allow a user 10 to apply their ELink rewards to other merchants' products on the ELink platform. A profile can be linked to a bank account or PayPal.

In another embodiment, users 10 of system 20 can be rated or scored (as mentioned above) by various parameters. Some examples are: their ability to influence their followers or non-followers to purchase products; their ability to influence others to spread ELinks and write and read reviews attached to Elinks; and their frequency of ELinking to particular or multiple products. An ELinked vendor user 10 can reward a customer user 10 for any of these reasons by offering more credits, cash, discounts, points, etc.

In another embodiment, after a user 10 makes a purchase through system 20, they have the opportunity to rate and write a review about the product. Because the purchase is made directly from the manufacturer, the review is assured to come directly from the buying user 10 and no one else. This feature provides other potential customer/users 10 with a true glimpse into the vendor's credibility and the product's market status as quantified by the compounded purchases and ratings assigned to a product.

In another embodiment, the present system 20 enables both customers/users 10 to see what products are trending not only in social chatter, but most importantly what people are actually buying. Specifically, buyer/users 10 have the ability to search profiles within specific categories of goods to see what people are buying, choose from the top products in those categories, and read the reviews on those products in real user 10 profiles.

A profile may advantageously include a listing of all of the goods that user 10 has purchased, what products they have reviewed, whose purchases they influenced (as a primary, secondary and/or tertiary reference and so on), and who influenced their purchases. Users 10 with the highest rating can be designated with a title, e.g., an “Influencer” or a “Sponsor.” Influencers are users 10 with the highest rating compiled as a result of proprietary matrix, which takes into account various parameters, such as how many other users 10 were influenced to purchase through an ELink, how many ELinks spread in social feed, how often the reviews are written, how many users 10 read those reviews, and so on. Once an Influencer has reached a certain status, they can become Sponsors. A Sponsor is an Influencer on system 20 that has been approached by a Vendor/user 10 and offered to sponsor a product or an offer based on their social clout (purchases by others) within the electronic universe. Sponsored ELinks can be clearly marked as such and the Influencer who decides to Sponsor an ELink product or manufacturer need not purchase the product to create a root Elink 100. As noted above in the examples, in one preferred embodiment, celebrities can be ELink Sponsors, which is similar to endorsing a company or a line of products. Any such Celebrity Sponsor ELinks may be clearly visible on the profile.

As another feature, Applicants note that the concept of product adoption may be considered a function of at least two concurrent processes: characteristic-based adoption (CBA) and peer influence (PI). CBA may be described as a consumer's propensity to adopt the product or focal behavior as a function of their individual characteristics. PI then incorporates the influence of an individual's peers on their adoption propensity. The two processes are likely additive with respect to the likelihood of product adoption. The overall propensity of a customer to adopt the product can be the sum of the probability to adopt spontaneously due to individual characteristics and the increased likelihood of adoption due to cumulative peer influence of a user's friends or network neighbors or public figures/opinion etc. Furthermore, susceptibility to peer influence may depend on the probability to adopt spontaneously due to individual characteristics. Increases in peer influence created by incentives for adopters to influence their friends cause wider exposure to the product. Moreover, the incentives that increase susceptibility of adopter's peers to influence cause a selective exposure to those peers who have a natural inclination to adopt the product or any focal behavior, creating more peer adoption in the network and amplifying the total available peer influence in the system, thus increasing the likelihood of conversion for those who are not early adopters.

Moreover, it is noted that product adoption is a prerequisite for peer influence because observational learning and enrollment is unlikely unless a peer has adopted the product. In addition, prior experience with the product is likely correlated with an adopter's desire to discuss the product with friends as well as their friends' likelihood of purchasing that product. Most studies on the subject find that local social environments start encouraging a behavior only after that behavior becomes prevalent in the environment. In addition, behavioral correlations in networks are typically short-ranged and do not exceed two hops, meaning the likelihood of the friend of a friend of an adopter being influenced by the original adopter's decision (without the friend adopting) is low. Therefore, peer influence can be expressed as the contribution of an adopter friend to one's propensity to adopt. Merchants can then manipulate this factor to stimulate initial and ongoing peer influence and encourage peer influence through the use of incentive schemes, described herein.

The present system 20 allows product producers/users 10 to leverage peer influence (PI) and product adoption features in a novel manner. For example, a merchant user 10 may choose to incentivize influencer/users 10, peers of influencer/users 10, or both. Since motivations driving each of these groups of individuals and the techniques used to affect their behavior differ significantly, merchant/user 10 may encourage current adopters to exert more influence on their peers or increase the susceptibility of potential users 10 to such influence. Thus system 20 allows the merchant to isolate and manipulate at least two strategies of plausible peer influence mechanisms that drive product diffusion scenarios—one where the influence is driven by the persuasion of adopters, and another where the influence is instead driven by the susceptibility to influence the adopters' peers. Capturing both of these influence mechanisms through the present system 20 provides a very unique insight into the fabric of social contagion.

The word-of-mouth generated by a customer/user 10 is likely to be proportional to the magnitude of the incentive the merchant offers to engage in such influence, while the likelihood of positive response to that word-of-mouth is assumed to be proportional to the incentives (i.e. discount on initial adoption) the merchant/user 10 offers to adopters referred by others. The exact amount of incentives can be presented in the form of tiered commission compensation for persuasion and discounts on adoption for susceptibility strategies.

The increases in adoption generated by referral programs (incentives) may be far greater than those generated by seeding (targeting, advertising) schemes, in large part because seeding effectiveness may be constrained by the small number of potentially influential consumers in the network. By providing incentives through system 30, merchant/users 10 are able to make typically ordinary consumer/users 10 influential by increasing their motivation to convince their friends about the value of the product and reducing their friends' inherent resistance to influence. While both persuasion and susceptibility incentives can be effective, the susceptibility strategy may have a greater effect on adoption per unit increase in the incentive. Incentives to respond positively to word-of-mouth (whether truly oral or via electronic means) diffuse a product through a network toward clusters of individuals with a greater likelihood of adoption, thereby creating higher levels of overall influence present in system 20.

Finally, by utilizing the present system 20, a merchant/user 10 can obtain the greatest possible number of customer/users 10 while simultaneously reducing the cost of advertising and marketing, as well as the cost of retailers. Customer/users 10 become able to purchase a product directly from a manufacturer/user 10, thereby receiving a lower price on that product, but also acting as a retailer of sorts by luring in other potential users 10 to purchase the same product through them. This is similar to what normal retailers do through advertising, but with the present system 20 replacing expensive advertising with word-of-mouth advertising.

The specifications discussed in this application have disclosed preferred embodiments of the present invention and, although specific descriptive terms are employed, they are used in a generic sense only and not for purposes of limitation. Obviously, many modifications and variations of the present invention are possible once the distinguishing characteristics of the present invention are understood. It is therefore to be understood that the present invention may be implemented otherwise than as specifically described in this application without changing the focus and advantages derived.

Unless defined otherwise, all technical and scientific terms used herein have the same meaning as commonly understood by one of ordinary skill in the art in the field of this present invention. Although any compositions, methods, implementations, configurations and means for communicating information similar or equivalent to those described herein can be used to practice this present invention, the preferred compositions, methods, implementations, configurations and means for communicating information are described herein.

Although the present invention has been described in accordance with the embodiments shown, one of ordinary skill in the art will readily recognize that there could be variations made to the embodiments without departing from the scope of the present invention. Accordingly, it is intended that all matter contained in the above application and shown in the accompanying drawings shall be interpreted as illustrative and not a means of demonstrating the limits of technology.

What is claimed is:

1. A method for managing the sale of goods and services, said method comprising:
at the request of a first vendor, coupling at least one good or service to a first hyperlink associated with said first vendor and said at least one good or service;
receiving from a first buyer at least one request for the purchase of said good or service coupled to said first hyperlink;
completing an electronic transaction between said first vendor and said first buyer for the purchase of said at least one good or service coupled to said first hyperlink;
tracking and storing in a database the purchase of said at least one good or service coupled to said first hyperlink;
generating a second hyperlink, said second hyperlink corresponding to said good or service as well as to both said first vendor and said first buyer, and supplying said second hyperlink to said first buyer,
wherein said first buyer may display said second hyperlink to a plurality of additional buyers, and
wherein when each of said plurality of additional buyers conducts a transaction using said second hyperlink to purchase said at least one good or service from said first vendor, said purchase is recorded in connection with said additional buyers, said first vendor and said first buyer.

2. The method as claimed in claim 1, wherein said hyperlink is a shortened ELink.

3. The method as claimed in claim 1, wherein when said transaction is conducted via said second hyperlink, at least a portion of money transacted between said additional buyer and said first vendor is appropriated to said first buyer, associated with said second hyperlink.

4. The method as claimed in claim 1, wherein for each of said additional plurality of buyers conducting a transaction using said second hyperlink to purchase said at least one good or service from said first vendor, said method further comprises the step of generating a third hyperlink associated with said at least one good or services as well as said first vendor, said first buyer and said additional buyer.

5. The method as claimed in claim 1, wherein said method includes the step of bypassing said transaction with said first buyer and having said first vendor directly generating a second hyperlink to be provided to a promoter.

6. The method as claimed in claim 1, further comprising the step of analyzing said tracked and stored purchases of said at least one good or service, wherein said method includes generating a report of the amount of second hyperlinks associated with both said at least one good or service and said first buyers.

7. The method as claimed in claim 1, wherein said first hyperlink associated with said at least one good or service and said first vendor is printed on a physical medium and is stored in proximity to a physical product in a retail location.

8. The method as claimed in claim 3, wherein said first vendor is in control of said portion of money transacted between said first buyer and said first vendor to be appropriated to said first buyer, associated with said second hyperlink.

9. The method as claimed in claim 8, wherein said first vendor can set a maximum amount of said money transacted between said first buyer and said first vendor to be appropriated to said first buyer and any additional buyers associated with said second hyperlink and third hyperlink.

10. The method as claimed in claim 1, wherein said first buyer can apply a review to said at least one good or service, to be attached to either one or both of said first hyperlink and second hyperlink.

11. A method for managing the promotion of goods and services, said method comprising:
at the request of a first vendor, coupling at least one good or service to a first hyperlink associated with said first vendor and said at least one good or service;
providing to a first promoter at least one first hyperlink coupled to said at least one good or service;
receiving an acknowledgement said first promoter has initiated a display of said first hyperlink on at least one internet site for promotion.
tracking and storing in a database the connection of at least one second promoter to said first hyperlink;
generating a second hyperlink, said second hyperlink corresponding to said good or service as well as to both said first vendor and said first promoter, and supplying said second hyperlink to said second promoter buyer,
wherein said second promoter may display said second hyperlink to a plurality of additional promoters, and
wherein when each of said plurality of additional promoters connects with said second hyperlink related to said at least one good or service from said first vendor, said additional promoter may request a third hyperlink, corresponding to each of said good or service as well as to said first vendor, said first promoter, said second promoter and said additional promoter.

12. The method as claimed in claim 11, wherein said first promoter is a buyer of said at least one good or service.

13. The method as claimed in claim 11, wherein said second promoter is a buyer of said at least one good or service.

14. The method as claimed in claim 11, wherein said additional promoter is a buyer of said at least one good or service.

15. The method as claimed in claim 11, wherein said step of initiating a display of said first hyperlink on at least one internet site for promotion includes displaying said first hyperlink on a social media site.

16. The method as claimed in claim 15, further comprising the step of tracking the distribution of each of said hyperlinks, from each of said promoters though said social media sites.

17. The method as claimed in claim 16, further comprising the step of providing said first vendor of said at least one good or service the ability to view said tracked distribution of said hyperlinks by at least a selection of said promoters, so as to allow said first vendor to select among available promoters.
